(19) United States
(12) Patent Application Publication
(10) Pub. No.: US 2011/0227387 A1
(43) Pub. Date: Sep. 22, 2011

(54) OCCUPANT CONTROLLED MULTI-SURFACE HEAD RESTRAINT FOR IMPROVED COMFORT

(76) Inventor: Michael Kolich, Windsor (CA)

(21) Appl. No.: 12/724,500

(22) Filed: Mar. 16, 2010

(51) Int. Cl. B60N 2/48; B23P 11/00

(52) U.S. Cl. 297/408; 297/391; 29/428

(57) ABSTRACT

A vehicle head restraint that includes a first surface and a second surface. The second surface includes at least one property distinct from the first surface, wherein the at least one property includes surface geometry and material. The head restraint is capable of adjusting between a first surface user accessible position and a second surface user accessible position, wherein each surface is designed to support a user head during a collision.

### FIELD OF THE INVENTION

The present invention generally relates to head restraints and more specifically concerns variable surface head restraints.

### BACKGROUND OF THE INVENTION

Head restraints located above seatbacks are well known. The head restraints function to limit the movement of a seated user's head in the event of a collision. As a secondary function, but typically of more practical meaning to a user, head restraints are designed to offer a comfortable surface for a seated user to rest their head upon while sitting in the vehicle. However, for various reasons, not all users prefer identical head restraint surfaces. Therefore, it would be advantageous to provide a user with multiple head restraint surface options.

### SUMMARY OF THE INVENTION

According to one aspect of the present invention, a vehicle head restraint is provided that includes a first surface and a second surface. The second surface includes at least one property distinct from the first surface, wherein the at least one property includes surface geometry and material. The head restraint is capable of adjusting between a first surface user accessible position and a second surface user accessible position, wherein each surface is designed to support a user head during a collision.

According to another aspect of the present invention, a seat is provided that includes a seatback and a head restraint attached to an upper portion of the seatback. The head restraint includes a first surface including a concave surface geometry. The head restraint further includes a second surface including a convex surface geometry. The head restraint is movable between a first surface user accessible position and a second surface user accessible position, wherein each surface is designed to support a user head during a collision.

According to yet another aspect of the present invention, a method is provided for manufacturing a head restraint. The method includes providing an interior. The method also includes sealably surrounding the interior with a plurality of surfaces, wherein at least one of the plurality of surfaces includes at least one property distinct from at least one of the other surfaces, and wherein the at least one property includes surface geometry and material. The method further includes removably attaching the head restraint to a seatback, wherein the head restraint is capable of adjusting between a plurality of surface user accessible positions, and wherein each surface is designed to support a user head during a collision.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a perspective view of a vehicle seat having a variable surface head restraint according to a first embodiment;

FIG. 1A is an enlarged side view of the head restraint in a first surface user accessible position;

FIG. 1B is an enlarged side view of the head restraint in a second surface user accessible position;

FIG. 2 is a perspective view of a vehicle seat having a variable surface head restraint according to a second embodiment;

FIG. 2A is an enlarged side view of the head restraint in a first surface user accessible position;

FIG. 2B is an enlarged side view of the head restraint in a second surface user accessible position;

FIG. 2C is an enlarged side view of the head restraint in a third surface user accessible position;

FIG. 2D is an enlarged side view of the head restraint in a fourth surface user accessible position;

FIG. 3 is a perspective view of a vehicle seat having a variable surface head restraint according to a third embodiment;

FIG. 3A is an enlarged side view of the head restraint in a first surface user accessible position;

FIG. 3B is an enlarged side view of the head restraint in transition between the first surface user accessible position and a second surface user accessible position; and

FIG. 3C is an enlarged side view of the head restraint in the second surface user accessible position.

### DETAILED DESCRIPTION OF PREFERRED EMBODIMENTS

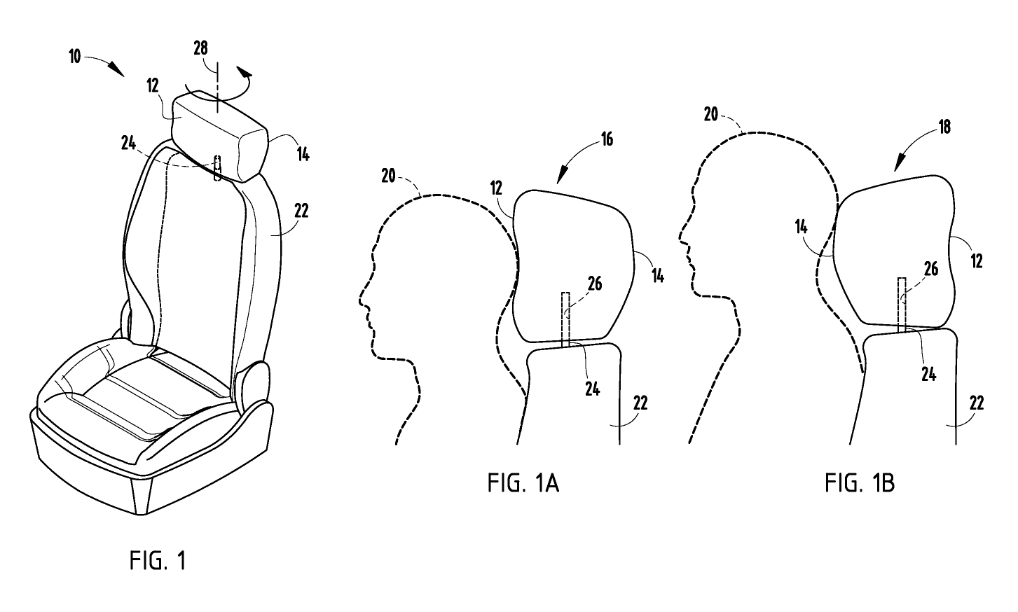

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIG. 1) generally designates a head restraint used in connection with the passenger seat in a vehicle, such as passenger automobiles, according to one embodiment. In the illustrated example, the head restraint 10 comprises a first surface 12 and a second surface 14. The second surface 14 includes at least one property distinct from the first surface 12, wherein the at least one property includes surface geometry and material. The head restraint 10 is capable of adjusting between a first surface user accessible position 16 and a second surface user accessible position 18, wherein each surface 12, 14 is designed to support a user head 20 during a collision.

FIGS. 1-1B illustrate a first embodiment of the head restraint 10. The head restraint 10 is attached to a vehicle seatback 22 via a single post 24 that extends in a substantially vertical manner from the seatback 22 to the head restraint 10. The post 24 is positioned proximate a central region of the seatback 22 and extends upwardly into a receiving cavity 26 of the head restraint 10. The head restraint 10 is rotatably movable about the longitudinal axis of the post 28. The rotatable mounting of the head restraint 10 to the seatback 22 provides the ability to maneuver the head restraint 10 from the first surface user accessible position 16 (FIG. 1A) to the second surface user accessible position 18 (FIG. 1B). To effectively maneuver the head restraint 10 from the first surface user accessible position 16 to the second surface user accessible position 18, a user simply rotates the head restraint 10 about the longitudinal axis of the post 28. It is conceivable that a locking mechanism will be in place to securely fix the head restraint 10 when the desired position is achieved.

The distinction between the first and second surface user accessible positions 16, 18 lies in the surface properties of the head restraint 10. The first surface user accessible position 16 includes a concave geometry, where the surface geometry of the first surface 12 recedes slightly inward, thereby providing a “cupping” effect to the user's head 20. In contrast, the second surface user accessible position 18 includes a convex geometry, where the surface geometry of the second surface 14 bows outward, thereby providing a more cushioned feel for the user's head 20. In addition to the head restraint property of surface geometry, the first and second surface user accessible positions 16, 18 may include a number of other unique properties that distinguish each position from the other.

Specifically, the surface material may vary, for example, where the first surface 12 includes leather, while the second surface 14 includes a fabric material. Yet another head restraint property distinction may be the hardness of the head restraint 10. The hardness preference of a user may be accommodated by including head restraint interior material that provides various hardness levels at the first and second surfaces 12, 14. For example, a higher density of interior material may be provided to give a more firm feel to a user at the first surface 12, while conversely, a lower density of interior material may be provided under the immediate surface of the second surface 14 to give a user a softer feel, similar to a cushion or pillow. It is conceivable that a number of other distinct properties may be included, in order to provide the user with additional preference options. It should be noted that the aforementioned property combinations, with respect to the first and second surfaces 12, 14, are merely illustrative and any combination of distinct properties may be employed to provide surface choices for the user.

Additionally, rather than two surface user accessible positions 16, 18, a greater number of surface user accessible positions may be provided. One specific example includes four distinct surfaces, where a user simply rotates the head restraint 10 about the longitudinal axis of the post 28 by approximately 90°, in order to move from one surface to another.

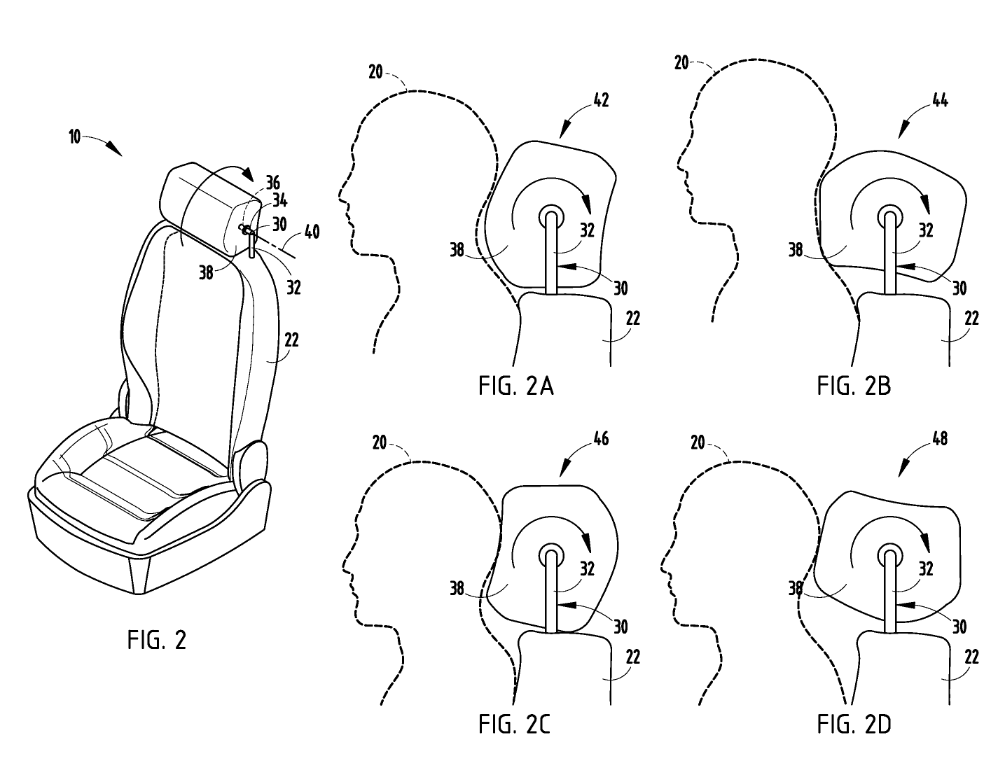

Another embodiment of the head restraint 10 is illustrated in FIGS. 2-2D. The distinct head restraint surface properties vary from surface to surface, as described above. Specifically, as is the case with the first embodiment, two or more surface user accessible positions may be provided. In this alternative embodiment, the head restraint 10 is attached to the seatback 22 via at least one post 30, where the at least one post 30 includes a substantially vertical portion 32 and a substantially horizontal portion 34. The at least one post 30 extends from, or out of, the seatback 22 in a substantially vertical manner, then angles inward toward the head restraint 10 in a substantially horizontal manner. The substantially horizontal portion 34 of the at least one post 30 extends into a receiving cavity 36 of the head restraint 10, where the receiving cavity 36 is disposed on a side surface 38 of the head restraint 10. The head restraint 10 is rotatably movable about the longitudinal axis of the horizontal portion 40 of the at least one post 30. The rotatable mounting of the head restraint 10 to the seatback 22 provides the ability to maneuver the head restraint 10 between the first surface user accessible position 42 (FIG. 2A) and the second surface user accessible position 44 (FIG. 2B). As previously described, a third surface user accessible position 46 (FIG. 2C) and a fourth surface user accessible position 48 (FIG. 2D) may be provided. To effectively maneuver the head restraint 10 between the plurality of user accessible positions, a user simply rotates the head restraint 10 about the longitudinal axis of the horizontal portion 40 of the at least one post 30. As described in the previous embodiment, it is conceivable that a locking mechanism will be in place to securely fix the head restraint 10 when the desired position is achieved.

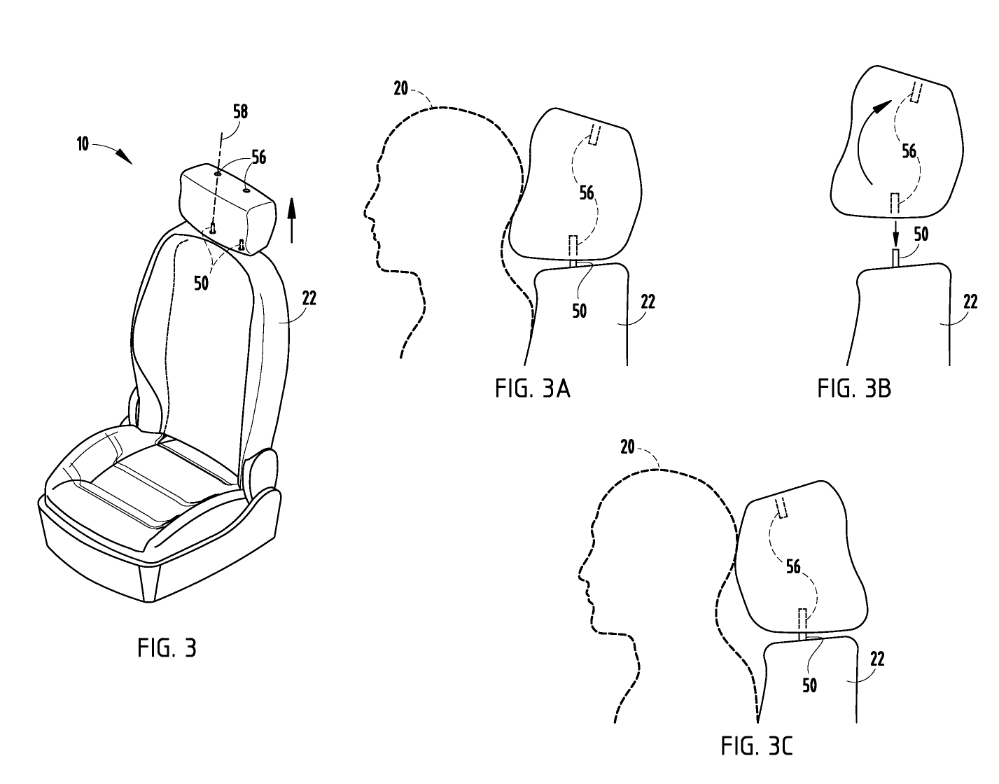

A third embodiment of the head restraint 10 is illustrated in FIGS. 3-3C. The distinct head restraint surface properties vary from surface to surface, as described above in the previous embodiments. Specifically, as is the case with the previous embodiments, two or more surface user accessible positions may be provided. In this alternative embodiment, the head restraint 10 is attached to the seatback 22 via at least one post 50. The at least one post 50 extends in a substantially vertical manner from the seatback 22 to the head restraint 10. The at least one post 50 extends upwardly into a receiving cavity 56 of the head restraint 10. The head restraint 10 is removably mounted to the at least one post 50. The removable mounting provides a user the ability to maneuver the head restraint 10 between the plurality of user accessible positions by simply removing the head restraint 10 from the at least one post 50. This is accomplished by sliding the head restraint 10 in a substantially vertical manner along the longitudinal axis 58 of the at least one post 50 until the head restraint 10 has achieved complete removal. The user may then manually rotate the head restraint 10 into a desired position and re-attach the head restraint 10 to the seatback 22 via the at least one post 50 thereby gaining access to the preferred user accessible position. As described in the previous embodiment, it is conceivable that a locking mechanism will be in place to securely fix the head restraint 10 when the desired position is achieved.

The present invention also provides a method for manufacturing the head restraint 10. The method includes providing an interior that is surroundably sealed by a plurality of surfaces. At least one of the plurality of surfaces includes at least one property distinct from at least one of the other surfaces. The structure of the distinct surfaces and the properties that may be varied are described in detail above. The head restraint 10 is removably attached to the seatback 22, and the head restraint 10 is capable of adjusting between a plurality of surface user accessible positions.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle head restraint comprising:
a first surface; and
a second surface having at least one property distinct from the first surface, wherein the at least one property comprises at least one of surface geometry and material, wherein the head restraint is capable of adjusting between a first surface user accessible position and a second surface user accessible position, wherein each surface is designed to support a user head during a collision.

2. The head restraint of claim 1, wherein the head restraint is attached to a seatback by a single post, wherein the single post is substantially vertically aligned, and wherein the head restraint is rotatable about a longitudinal axis of the single post.

3. The head restraint of claim 1, wherein the head restraint is removably attached to a seatback by a plurality of posts, wherein the plurality of posts are substantially vertically aligned.

4. The head restraint of claim 1, wherein the head restraint is attached to a seatback by at least one post, at least a portion of the at least one post substantially horizontally aligned, and wherein the head restraint is rotatable about a substantially horizontal axis.

5. The head restraint of claim 1, further comprising:
a third surface, wherein the third surface includes at least one property distinct from the first surface and the second surface, wherein the at least one property comprises surface geometry and material; and
a fourth surface, wherein the fourth surface includes at least one property distinct from the first surface, the second surface and third surface, wherein the at least one property comprises surface geometry and material, and wherein the head restraint is capable of adjusting between a first surface user accessible position, a second surface user accessible position, a third surface user accessible position, and a fourth surface user accessible position.

6. The head restraint of claim 1, wherein the first surface geometry includes a concave surface geometry, and wherein the second surface includes a convex surface geometry.

7. The head restraint of claim 6, wherein the second surface has a lower hardness value than the first surface.

8. The head restraint of claim 1, wherein the first surface includes a leather material, and wherein the second surface includes a fabric material.

9. A seat comprising:
a seatback; and
a head restraint attached to an upper portion of the seatback, comprising:
a first surface comprising a concave surface geometry; and
a second surface comprising a convex surface geometry, wherein the head restraint is movable between a first surface user accessible position and a second surface user accessible position, wherein each surface is designed to support a user head during a collision.

10. The seat of claim 9, wherein the head restraint is attached to the seatback by a single post, wherein the single post is substantially vertically aligned, and wherein the head restraint is rotatable about a longitudinal axis of the single post.

11. The seat of claim 9, wherein the head restraint is removably attached to the seatback by a plurality of posts, wherein the plurality of posts are substantially vertically aligned.

12. The seat of claim 9, wherein the head restraint is attached to the seatback by at least one post, at least a portion of the at least one post substantially horizontally aligned, and wherein the head restraint is rotatable about a substantially horizontal axis.

13. The seat of claim 9, further comprising:
a third surface, wherein the third surface includes at least one property distinct from the first surface and the second surface, wherein the at least one property comprises surface geometry and material; and
a fourth surface, wherein the fourth surface includes at least one property distinct from the first surface, the second surface and third surface, wherein the at least one property comprises surface geometry and material, and wherein the head restraint is capable of adjusting between a first surface user accessible position, a second surface user accessible position, a third surface user accessible position, and a fourth surface user accessible position.

14. The seat of claim 9, wherein the second surface has a lower hardness value than the first surface.

15. The seat of claim 9, wherein the first surface includes a leather material, and wherein the second surface includes a fabric material.

16. A method for manufacturing a head restraint comprising:
providing an interior;
sealably surrounding the interior with a plurality of surfaces, wherein at least one of the plurality of surfaces includes at least one property distinct from at least one of the other surfaces, wherein the at least one property comprises surface geometry and material;
removably attaching the head restraint to a seatback, wherein the head restraint is capable of adjusting between a plurality of surface user accessible positions, wherein each surface is designed to support a user head during a collision.

17. The method for manufacturing a head restraint of claim 16, wherein the step of removably attaching the head restraint to the seatback further includes attachment by a single post, wherein the single post is substantially vertically aligned, and wherein the head restraint is rotatable about a longitudinal axis of the single post.

18. The method for manufacturing a head restraint of claim 16, wherein the step of removably attaching the head restraint to the seatback further includes attachment by at least one post, at least a portion of the at least one post substantially horizontally aligned, and wherein the head restraint is rotatable about a substantially horizontal axis.

19. The method for manufacturing a head restraint of claim 16, wherein the step of removably attaching the head restraint to the seatback further includes attachment by a plurality of posts, wherein the plurality of posts are substantially vertically aligned.

20. The method for manufacturing a head restraint of claim 19, further comprising the step of adjusting between the plurality of surface user accessible positions by slidably elevating the head restraint along the plurality of posts to a point of complete removal, rotating the head restraint about a substantially vertical axis, positioning a plurality of post receiving apertures, located within the head restraint, above the plurality of posts, and inserting the plurality of posts within the post receiving apertures, thereby attaching the head restraint to the seatback.
